(19) United States
(12) Patent Application Publication
(10) Pub. No.: US 2026/0332021 A1
(43) Pub. Date: Oct. 22, 2026

(54) POWER SUPPLY PARALLEL SYSTEM AND POWER SUPPLY CONTROL METHOD

(71) Applicant: OmniOn Power Technology GmbH, Baden (CH)

(72) Inventors: Zhongmin Huang, Shanghai City (CN); Wen Luo, Shanghai City (CN); Jie Xu, Shanghai City (CN)

(21) Appl. No.: 19/319,191

(22) Filed: Sep. 4, 2025

(30) Foreign Application Priority Data
Apr. 16, 2025 (CN) 202510476035.0

(51) Int. Cl. H02M 1/00; H02M 3/04

(52) U.S. Cl. CPC H02M 1/0012; H02M 3/04

(57) ABSTRACT

Power supply parallel system includes voltage conversion circuits. Each of voltage conversion circuits includes a current sharing terminal, a voltage converter and a controller. Current sharing terminal of each of voltage conversion circuits are coupled to each other to form a parallel structure so as to transmit a sharing current through the parallel structure. Voltage converter converts a first input voltage into a first output voltage according to a first pulse width modulation signal. Controller receives first output voltage, first output current and sharing current. Controller performs following operations: adjusting the first pulse width modulation signal into a second pulse width modulation signal according to the first output current and the sharing current; and controlling the voltage converter to adjust the first output voltage into a second output voltage and to adjust the first output current to a second output current according the second pulse width modulation signal.

### CROSS-REFERENCE TO RELATED APPLICATION

This application claims priority to China Application Serial Number 202510476035.0, filed Apr. 16, 2025, which is herein incorporated by reference in its entirety.

### BACKGROUND

### Field of Invention

The present disclosure relates to an electronic system and a control method. More particularly, the present disclosure relates to a power supply parallel system and a power supply control method.

### Description of Related Art

To ensure the stability and reliability of the power supply system, most power supply systems now modularize the power supply and connect power modules of a specific specification series in series or in parallel. When multiple power modules are connected in parallel, it is still not possible to completely ensure that the entire power system can work stably. Due to the individual differences of multiple power modules and the impedance differences on the output lines, the current output by each power module will be unequal. In severe cases, the module with excessive load may experience overcurrent or overheating protection.

The existing technology is mainly divided into active current balancing method and passive current balancing method. The active current balancing method is the output impedance method. The output impedance method mainly achieves current sharing by adjusting the output voltage of the power module. When the current of a single power module increases, its output voltage will decrease accordingly, thereby reducing the load of a single module and causing the current of other modules to increase relatively. This method is simple and easy to implement, but it may cause output voltage deviation and affect the quality of the power supply.

The passive current balancing method can be implemented as a master-slave setting method, an average current method and a peak current method. The master-slave setting method mainly controls the current output of other slave power modules by setting one power module as the master power module. The master power module is responsible for monitoring the total current and adjusting the current of the slave power module as needed. This method can achieve accurate current sharing control, but it has high requirements on the reliability and stability of the master power module. If the master power module fails abnormally, the entire power system will not work. The average current method mainly connects all power modules through a current sharing bus to achieve average current distribution. Each power module detects its own current and compares it with the average current on the current sharing bus, and then automatically adjusts its output voltage to achieve the purpose of current sharing. The peak current method mainly selects a peak current module automatically, and other power modules are adjusted based on the peak current module. This method is simple and can achieve automatic current sharing, but it may not be stable enough when the load changes greatly.

For the foregoing reasons, there is a need for providing a suitable power supply parallel system and a power supply control method to solve the above problems encountered in related art approaches.

### SUMMARY

One aspect of the present disclosure provides a power supply parallel system. The power supply parallel system includes a plurality of voltage conversion circuit. Each of the voltage conversion circuit includes a current sharing terminal, a voltage converter and a controller. The current sharing terminal of each of the voltage conversion circuits are coupled to each other to form a parallel structure so as to transmit a sharing current through the parallel structure. The voltage converter is configured to convert a first input voltage into a first output voltage according to a first pulse width modulation signal, wherein the voltage converter is configured to generate a first output current. The controller, configured to receive the first output voltage, the first output current and the sharing current. The controller is configured to perform following operations: adjusting the first pulse width modulation signal into a second pulse width modulation signal according to the first output current and the sharing current; and controlling the voltage converter to adjust the first output voltage into a second output voltage and to adjust the first output current to a second output current according the second pulse width modulation signal.

In some embodiments, the controller is further configured to perform following operations: comparing the first output current with the sharing current to generate a current comparison value; filtering the current comparison value to obtain a current value; and calculating a virtual impedance value according to the current value and a droop factor.

In some embodiments, the controller further includes a first digital operational circuit. The first digital operational circuit is configured to calculate the virtual impedance value according to the current value and the droop facto.

In some embodiments, the controller is further configured to perform following operations: calculating a virtual voltage value according to the virtual impedance value and the first output current; and calculating a voltage calculated value according to an expected voltage and the virtual voltage value.

In some embodiments, the controller further comprises a second digital operational circuit and a third digital operational circuit. The second digital operational circuit is configured to calculate the virtual voltage value according to the virtual impedance value and the first output current. The third digital operational circuit is configured to calculate the voltage calculated value according to the expected voltage and the virtual voltage value.

In some embodiments, the second digital operational circuit is a multiplier. The third digital operational circuit is a subtractor.

In some embodiments, the controller is further configured to perform following operations: comparing the first output voltage with the calculated voltage value to generate a comparison signal; and adjusting the first pulse width modulation signal into the second pulse width modulation signal according to the comparison signal.

In some embodiments, the sharing current is an average current of the first output current of each of the voltage conversion circuits.

In some embodiments, the voltage converter is a direct current (DC) to DC converter.

Another aspect of the present disclosure provides a power supply control method. The power supply parallel system is adapted to a power supply parallel system. The power supply parallel system includes a plurality of voltage conversion circuits. Each of the voltage conversion circuits comprises a current sharing terminal, a voltage converter and a controller. The current sharing terminal of each of the voltage conversion circuit are coupled to each other to form a parallel structure so as to transmit a sharing current through the parallel structure. The power supply control method includes: converting a first input voltage into a first output voltage according to a first pulse width modulation signal and generating a first output current by the voltage converter; adjusting the first pulse width modulation signal into a second pulse width modulation signal according to the first output current and the sharing current by the controller; and controlling the voltage converter to adjust the first output voltage into a second output voltage and to adjust the first output current to a second output current according the second pulse width modulation signal by the controller.

In some embodiments, the step of adjusting the first pulse width modulation signal into the second pulse width modulation signal according to the first output current and the sharing current by the controller includes: comparing the first output current with the sharing current to generate a current comparison value by the controller; filtering the current comparison value to obtain a current value by the controller; and calculating a virtual impedance value according to the current value and a droop factor by the controller.

In some embodiments, the step of adjusting the first pulse width modulation signal into the second pulse width modulation signal according to the first output current and the sharing current by the controller further includes: calculating a virtual voltage value according to the virtual impedance value and the first output current by the controller; and calculating a voltage calculated value according to an expected voltage and the virtual voltage value by the controller.

In some embodiments, the step of adjusting the first pulse width modulation signal into the second pulse width modulation signal according to the first output current and the sharing current by the controller further includes: comparing the first output voltage with the calculated voltage value to generate a comparison signal by the controller; and adjusting the first pulse width modulation signal into the second pulse width modulation signal according to the comparison signal by the controller.

In some embodiments, the sharing current is an average current of the first output current of each of the voltage conversion circuits.

In some embodiments, the voltage converter is a direct current (DC) to DC converter.

In view of the aforementioned shortcomings and deficiencies of the prior art, the present disclosure provides a technology of power supply parallel system and a power supply control method, which can accurately match the impedance of all voltage conversion circuits in the power parallel system through the internal resistance coefficient of the controller of the voltage conversion circuit of the power parallel system, thereby achieving a stable and high-precision current sharing effect.

### BRIEF DESCRIPTION OF THE DRAWINGS

The present disclosure can be more fully understood by reading the following detailed description of the embodiment, with reference made to the accompanying drawings as follows:

FIG. 1 depicts a schematic diagram of a power supply parallel system according to some embodiments of the present disclosure;

FIG. 2 depicts a schematic diagram of a controller of a voltage conversion circuit of a power supply parallel system according to some embodiments of the present disclosure;

FIG. 3 depicts a schematic diagram of a controller of a voltage conversion circuit of a power supply parallel system according to some embodiments of the present disclosure;

FIG. 4 depicts a flow chart of a power supply control method according to some embodiments of the present disclosure; and

FIG. 5 depicts a schematic diagram of an output current and an output impedance according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise.

Furthermore, it should be understood that the terms, “comprising”, “including”, “having”, “containing”, “involving” and the like, used herein are open-ended, that is, including but not limited to.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

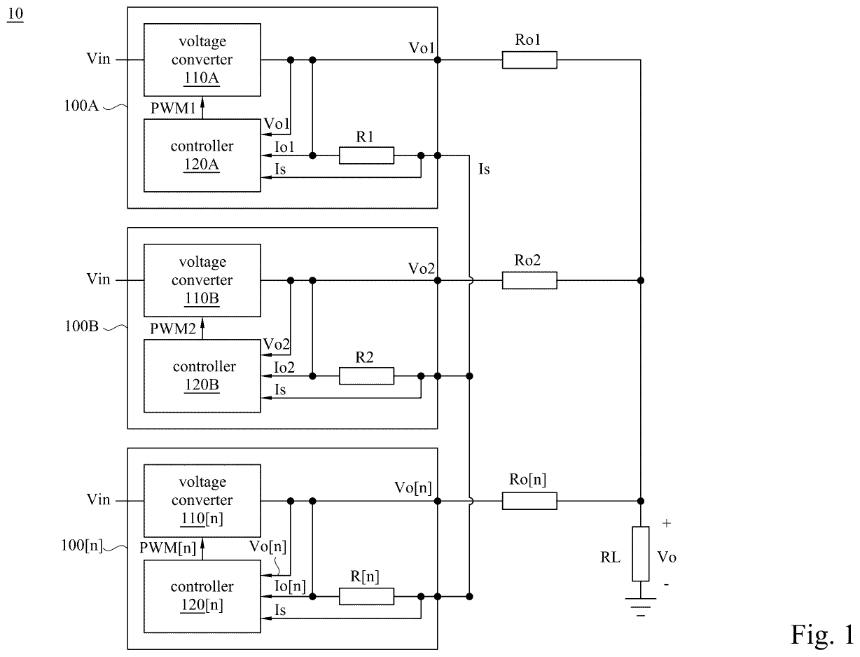

FIG. 1 depicts a schematic diagram of a power supply parallel system 10 according to some embodiments of the present disclosure. In some embodiments, please refer to FIG. 1, the power supply parallel system 10 comprise a plurality of voltage conversion circuits (e.g., a voltage conversion circuit 100A, a voltage conversion circuit 100B and a voltage conversion circuit 100[n]). Each of the voltage conversion circuits includes a power input terminal and a power output terminal. The power input terminals of each of the voltage conversion circuits are electrically connected to the input voltage source to receive an input voltage Vin. In some embodiments, the input voltage Vin can be implemented as a direct current (DC) voltage.

The power output terminal of the voltage conversion circuit 100A is configured to transmit an output voltage Vo1, and is electrically connected to an output resistor Ro1 and a load RL. The power output terminal of the voltage conversion circuit 100B is configured to transmit an output voltage Vo2, and is electrically connected to an output resistor Ro2 and the load RL. The power output terminal of the voltage conversion circuit 100[n] is configured to transmit an output voltage Vo[n], and is electrically connected to an output resistor Ro[n] and the load RL. In other words, the power output terminals of the plurality of voltage conversion circuits are also connected to each other so as to be commonly connected to the load RL to form a parallel system. In some embodiments, the output voltage Vo1, the output voltage Vo2 and the output voltage Vo[n] can be implemented as a DC voltage.

Each of the voltage conversion circuits (e.g., the voltage conversion circuit 100A, the voltage conversion circuit 100B and the voltage conversion circuit 100[n]) further includes a current sharing terminal. the current sharing terminal of each of the voltage conversion circuits are coupled to each other to form a parallel structure so as to transmit a sharing current Is through the parallel structure. The sharing current Is is an average current of the output current (e.g., an output current Io1, an output current Io2 and an output current Io[n]) of each of the voltage conversion circuits (e.g., the voltage conversion circuit 100A, voltage conversion circuit 100B and the voltage conversion circuit 100[n]).

The voltage conversion circuit 100A include a voltage converter 110A, controller 120A and a resistor R1. The voltage converter 110A is configured to convert the input voltage Vin into the output voltage Vo1, and is configured to generate an output current Io1 according to a pulse width modulation signal PWM1. The controller 120A is configured to receive the output voltage Vo1, output current Io1 and the sharing current Is. In some embodiments, the voltage converter 110A can be implemented as a DC to DC converter.

Please refer to FIG. 1, the voltage conversion circuit 100B includes a voltage converter 110B, a controller 120B and a resistor R2. The voltage converter 110B is configured to convert the input voltage Vin into the output voltage Vo2, and is configured to generate an output current Io2 according to a pulse width modulation signal PWM2. The controller 120B is configured to receive the output voltage Vo2, the output current Io2 and the sharing current Is. In some embodiments, the voltage converter 110B can be implemented as a DC to DC converter.

The voltage conversion circuit 100[n] includes a voltage converter 110[n], a controller 120[n] and a resistor R[n]. The voltage converter 110[n] is configured to convert the input voltage Vin into the output voltage Vo[n] and is configured to generate an output current Io[n] according to a pulse width modulation signal PWM[n]. The controller 120[n] is configured to receive the output voltage Vo[n], the output current Io[n] and the sharing current Is. In some embodiments, the voltage converter 110[n] can be implemented as a DC to DC converter. It should be noted that a number of the voltage conversion circuits can be designed according to actual needs and are not limited to the embodiments of the present disclosure.

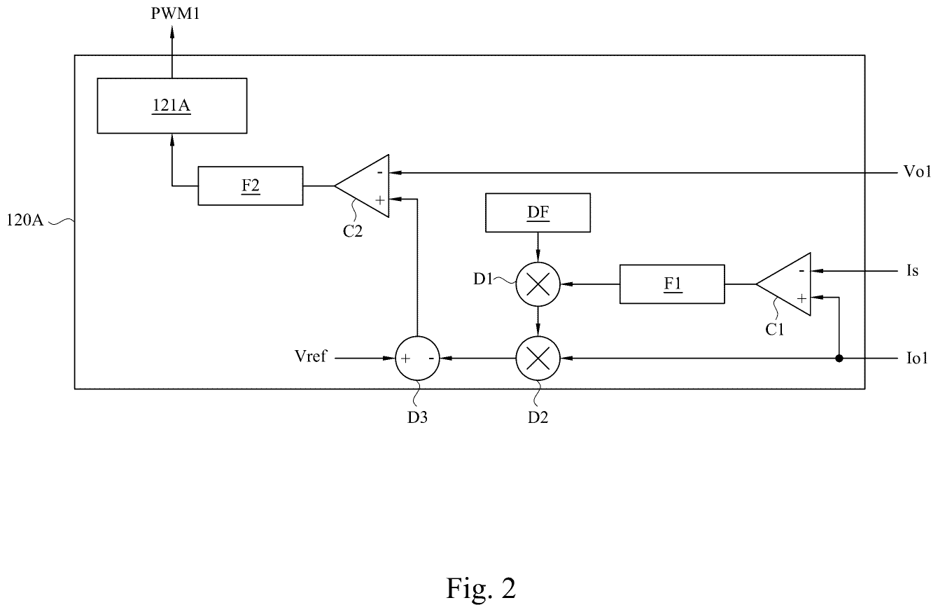

FIG. 2 depicts a schematic diagram of a controller 120 A of a voltage conversion circuit 100A of the power supply parallel system 10 in FIG. 1 according to some embodiments of the present disclosure. Please refer to FIG. 2, the controller 120A includes a comparator C1, a filter F1, a droop factor generation circuit DF, a digital operational circuit D1, a digital operational circuit D2, a digital operational circuit D3, a comparator C2, a filter F2 and a pulse width modulation signal generator 121A.

The comparator C1 is configured to receive the output current Io1 and the sharing current Is. The filter F1 is coupled to the comparator C1. In some embodiments, the filter F1 can be implemented as an integrator to simply filter a value calculated by comparator C1. In some embodiments, the filter F1 can be implemented as a proportional-integral-derivative controller (PID controller) to filter and compensate the value calculated by comparator C1. The PID controller is a common feedback loop element in industrial control applications.

The digital operational circuit D1 is coupled to the droop factor generation circuit DF and the filter F1. The digital operational circuit D2 is coupled to the digital operational circuit D1. The digital operational circuit D3 is coupled to the digital operational circuit D2. In some embodiments, each of the digital operational circuit D1 and the digital operational circuit D2 can be implemented as a multiplier. The digital operational circuit D3 can be implemented as a subtractor.

The comparator C2 is coupled to the digital operational circuit D3 and the filter F2, and is configured to receive the output voltage Vo1. The pulse width modulation signal generator 121A is coupled to the filter F2, and is configured to output the pulse width modulation signal PWM1.

It should be noted that, please refer to FIG. 1 and FIG. 2, an internal circuit structure of each the controller 120B of the voltage conversion circuit 100B and the controller 120[n] of the voltage conversion circuit 100[n] is similar to an internal circuit structure of controller 120A of the voltage conversion circuit 100A, and detail repetitious descriptions are omitted here.

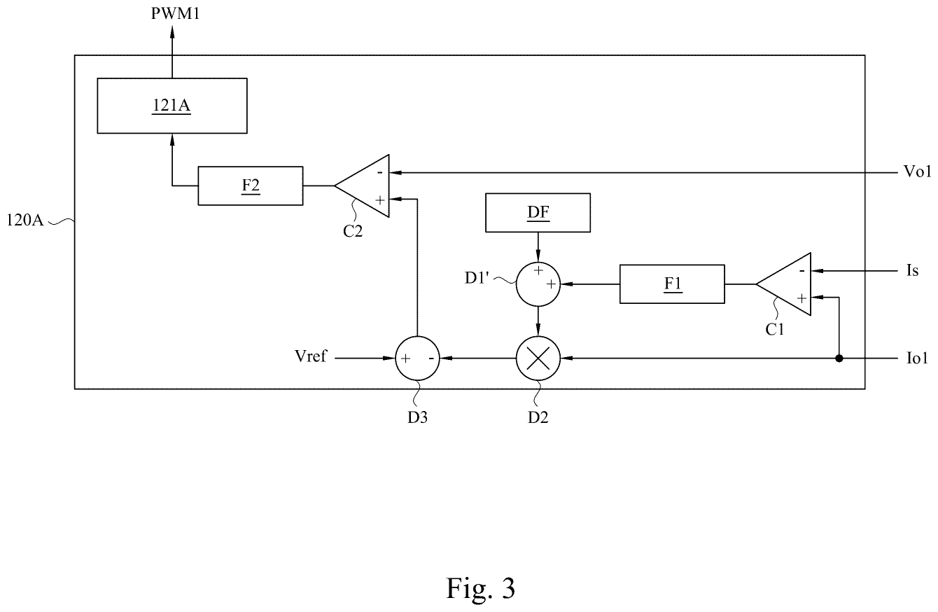

FIG. 3 depicts a schematic diagram of the controller 120A of the voltage conversion circuit 100A of the power supply parallel system 10 in FIG. 1 according to some embodiments of the present disclosure. Please refer to FIG. 3, the controller 120A includes a comparator C1, a filter F1, a droop factor generation circuit DF, a digital operational circuit D1′, a digital operational circuit D2, a digital operational circuit D3, a comparator C2, a filter F2 and a pulse width modulation signal generator 121A. Connection methods and operations of the comparator C1, the filter F1, the droop factor generation circuit DF, the digital operational circuit D1′, the digital operational circuit D2, the digital operational circuit D3, the comparator C2, the filter F2 and the pulse width modulation signal generator 121A are respectively similar to connection methods and operations of the corresponding components in the controller 120A in FIG. 2. For the sake of brevity, only the differences are described below.

Compared with the embodiment in FIG. 2, a difference between the embodiment in FIG. 2 and the embodiment in FIG. 3 is that the digital operational circuit D1′ can be implemented as a subtractor or an adder.

It is further explained that the architecture of the embodiment in FIG. 2 and the embodiment in FIG. 3 are only examples, and the present disclosure is not limited thereto. It will be understood by those of ordinary skill in the art that various modifications and applications may be made without departing from essential characteristics of the aspects. For example, the elements described in detail in the above aspects may be modified. In addition, differences related to these modifications and applications should be construed as being covered by the scope of the invention as defined by the following claims.

In some embodiments, internal components of the controller 120A in FIG. 2 and the controller 120A in FIG. 3 (e.g., the comparator C1, the filter F1, the droop factor generation circuit DF, the digital operational circuit D1, the digital operational circuit D2, the digital operational circuit D3, the comparator C2, the filter F2 and the pulse width modulation signal generator 121A) can be implemented as a collection of multiple electronic physical components (such as multiple transistors and capacitors). In some embodiments, the internal components of the controller 120A in FIG. 2 and the controller 120A in FIG. 3 (e.g., the comparator C1, the filter F1, the droop factor generation circuit DF, the digital operational circuit D1, the digital operational circuit D2, the digital operational circuit D3, the comparator C2, the filter F2 and the pulse width modulation signal generator 121A) can be implemented digital operations performed by programs.

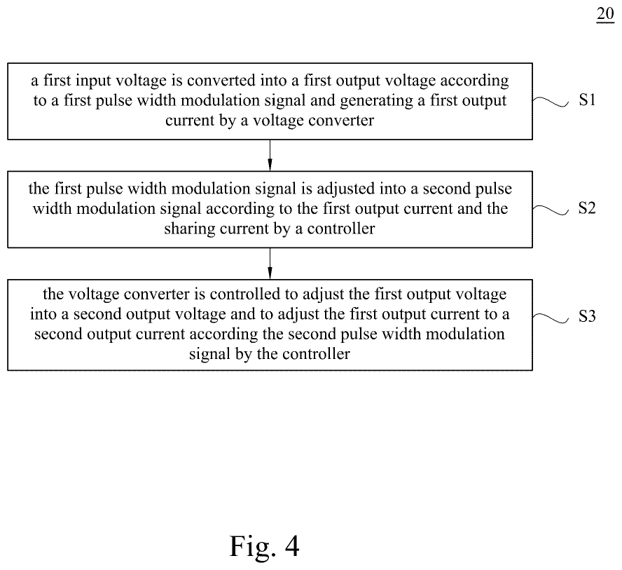

In order to facilitate the understanding an operation of the controller 120A of the voltage conversion circuit 100A of the power supply parallel system 10 of the present disclosure, please refer to FIG. 1, FIG. 2 and FIG. 4. FIG. 4 depicts a flow chart of a power supply control method 20 according to some embodiments of the present disclosure. The power supply control method 20 includes a step S1 to a step S3. The power supply control method 20 can be executed by the power supply parallel system 10 in FIG. 1.

In step S1, please refer to FIG. 1, FIG. 2 and FIG. 4, the voltage converter 110A is configured to convert the input voltage Vin into the output voltage Vo1 according to the pulse width modulation signal PWM1, and is configured to generate the output current Io1. The voltage converter 110B is configured to convert the input voltage Vin into the output voltage Vo2 according to the pulse width modulation signal PWM2, and is configured to generate the output current Io2.

In step S2, please refer to FIG. 1, FIG. 2 and FIG. 4, the controller 120A is configured to adjust the pulse width modulation signal PWM1 into a new pulse width modulation signal (not shown in the figure) according to the output current Io1 and the sharing current Is. Since the internal circuit structure and operation of each of the controller 120B of the voltage conversion circuit 100B and the controller 120[n] of the voltage conversion circuit 100[n] is similar to the internal circuit structure and operation of the controller 120A of the voltage conversion circuit 100A. For the sake of brevity, detail repetitious descriptions are omitted here.

In some embodiments, the comparator C1 of the controller 120A is configured to compare the output currentIo1 with the sharing current Is to generate a current comparison value. The filter F1 of the controller 120A is configured to filter the current comparison value to obtain a current value. The digital operational circuit D1 of the controller 120A is configured to calculate a virtual impedance value according to the current value and a droop factor provided by the droop factor generation circuit DF. The digital operational circuit D2 of the controller 120A is configured to calculate a virtual voltage value according to the virtual impedance value and the output current Io1. The digital operational circuit D3 of the controller 120A is configured to calculate a voltage calculated value according to an expected voltage Vref and the virtual voltage value.

Then, please refer to FIG. 1, FIG. 2 and FIG. 4, the comparator C2 of the controller 120A is configured to compare the output voltage Vo1 with the calculated voltage value to generate a comparison signal. The filter F2 of the controller 120A is configured to filter the comparison signal. The pulse width modulation signal generator 121A of the controller 120A is configured to adjust the pulse width modulation signal PWM1 into a new pulse width modulation signal (not shown in figure) according to the filtered comparison signal.

In step S3, please refer to FIG. 1, FIG. 2 and FIG. 4, the controller 120A is configured to control the voltage converter 110A to adjust the output voltage Vo1 into the output voltage Vo1′ and to adjust the output current Io1 into the output current IF according to the new pulse width modulation signal. The controller 120B is configured to control the voltage converter 110B to adjust the output voltage Vo2 into the output voltage Vo2′ and to adjust the output current Io2 into the output current IF according to the new pulse width modulation signal.

When the digital operational circuit D1 of the controller 120A is configured to calculate the virtual impedance value according to the droop factor, the equivalent impedance value of the voltage conversion circuit 100A and the output resistor Ro1 has changed, so that the output voltage Vo1 of the voltage conversion circuit 100A gradually decreases until the equivalent impedance values of other voltage conversion circuits and output resistors (for example, the voltage conversion circuit 100B and the output resistor Ro2) are the same.

In other word, each of the voltage conversion circuits (e.g., the voltage conversion circuit 100A and the voltage conversion circuit 100B) continuously adjusts the equivalent impedance value through the feedback output voltage output voltage (e.g., the output voltage Vo1 and the output voltage Vo2), the output current(e.g., the output current Io1 and the output current Io2) and the sharing current Is until the equivalent impedance values of all the voltage conversion circuits and the output resistors (e.g., the voltage conversion circuit 100A and the output resistor Ro1, and the voltage conversion circuit 100B and the output resistor Ro2) are the same.

At this time, the output voltage Vo1 of the voltage conversion circuit 100A and the output voltage Vo2 of the voltage conversion circuit 100B will decrease until they are close to the same, so as to achieve the effect of voltage balancing. At the same time, the output current Io1 of the voltage conversion circuit 100A and the output current Io2 of the voltage conversion circuit 100B also decrease until they are close to the same.

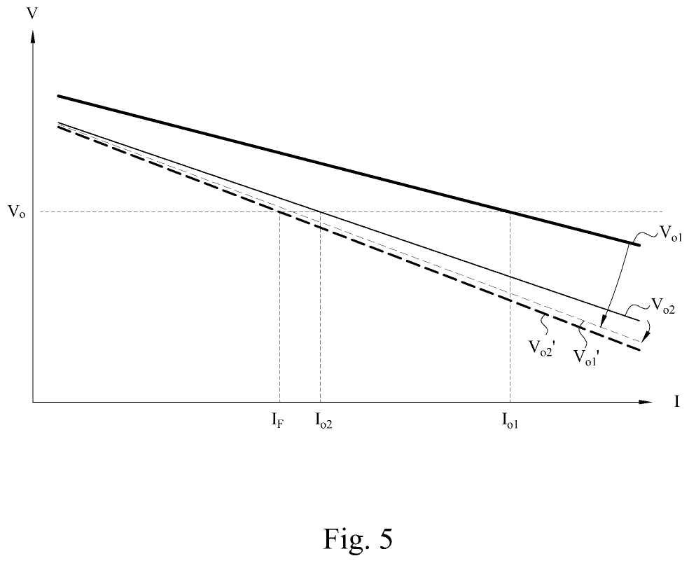

FIG. 5 depicts a schematic diagram of an output current and an output impedance according to some embodiments of the present disclosure. As shown in FIG. 5, the vertical axis represents the output voltage V (in volts), and the horizontal axis represents the output current I (in amperes). The voltage conversion circuit 100A and the voltage conversion circuit 100B respectively have different output voltages (e.g., the output voltage Vo1 and the output voltage Vo2 shown in FIG. 5) and different output currents (e.g., the output current Io1 and the output current Io2 shown in FIG. 5). When the equivalent impedance values of the voltage conversion circuits re the same and the power supply is stable, the output voltage of the voltage conversion circuit 100A is the output voltage Vo1′ and the output voltage of the voltage conversion circuit 100b is the

output voltage Vo2′. The output voltages of the two are similar, which helps to achieve voltage balancing. At this time, the output current of each of the voltage conversion circuit 100A and the voltage conversion circuit 100B is the current IF. The output currents of the two are similar, which helps to achieve current sharing.

Based on the aforementioned embodiments, the present disclosure provides a technology of a power supply parallel system and a power supply control method, which can accurately match impedances of all voltage conversion circuits in the power supply parallel system through the internal droop factor of the controller of the voltage conversion circuit of the power supply parallel system, thereby achieving a stable and high-precision current sharing effect.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A power supply parallel system, comprising:
a plurality of voltage conversion circuits, wherein each of the voltage conversion circuits comprises:
a current sharing terminal, wherein the current sharing terminal of each of the voltage conversion circuits are coupled to each other to form a parallel structure so as to transmit a sharing current through the parallel structure;
a voltage converter, configured to convert a first input voltage into a first output voltage according to a first pulse width modulation signal, wherein the voltage converter is configured to generate a first output current; and
a controller, configured to receive the first output voltage, the first output current and the sharing current, wherein the controller is configured to perform following operations:
adjusting the first pulse width modulation signal into a second pulse width modulation signal according to the first output current and the sharing current; and
controlling the voltage converter to adjust the first output voltage into a second output voltage and to adjust the first output current to a second output current according the second pulse width modulation signal.

2. The power supply parallel system of claim 1, wherein the controller is further configured to perform following operations:
comparing the first output current with the sharing current to generate a current comparison value;
filtering the current comparison value to obtain a current value; and
calculating a virtual impedance value according to the current value and a droop factor.

3. The power supply parallel system of claim 2, wherein the controller further comprises a first digital operational circuit, wherein the first digital operational circuit is configured to calculate the virtual impedance value according to the current value and the droop factor.

4. The power supply parallel system of claim 2, wherein the controller is further configured to perform following operations:
calculating a virtual voltage value according to the virtual impedance value and the first output current; and
calculating a voltage calculated value according to an expected voltage and the virtual voltage value.

5. The power supply parallel system of claim 4, wherein the controller further comprises a second digital operational circuit and a third digital operational circuit, wherein the second digital operational circuit is configured to calculate the virtual voltage value according to the virtual impedance value and the first output current, wherein the third digital operational circuit is configured to calculate the voltage calculated value according to the expected voltage and the virtual voltage value.

6. The power supply parallel system of claim 5, wherein the second digital operational circuit is a multiplier, wherein the third digital operational circuit is a subtractor.

7. The power supply parallel system of claim 4, wherein the controller is further configured to perform following operations:
comparing the first output voltage with the calculated voltage value to generate a comparison signal; and
adjusting the first pulse width modulation signal into the second pulse width modulation signal according to the comparison signal.

8. The power supply parallel system of claim 1, wherein the sharing current is an average current of the first output current of each of the voltage conversion circuits.

9. The power supply parallel system of claim 1, wherein the voltage converter is a direct current (DC) to DC converter.

10. A power supply control method, adapted to a power supply parallel system, wherein the power supply parallel system comprises a plurality of voltage conversion circuits, wherein each of the voltage conversion circuits comprises a current sharing terminal, a voltage converter and a controller, wherein the current sharing terminal of each of the voltage conversion circuit are coupled to each other to form a parallel structure so as to transmit a sharing current through the parallel structure, wherein the power supply control method comprises:
converting a first input voltage into a first output voltage according to a first pulse width modulation signal and generating a first output current by the voltage converter;
adjusting the first pulse width modulation signal into a second pulse width modulation signal according to the first output current and the sharing current by the controller; and
controlling the voltage converter to adjust the first output voltage into a second output voltage and to adjust the first output current to a second output current according the second pulse width modulation signal by the controller.

11. The power supply control method of claim 10, wherein adjusting the first pulse width modulation signal into the second pulse width modulation signal according to the first output current and the sharing current by the controller comprises:
comparing the first output current with the sharing current to generate a current comparison value by the controller;
filtering the current comparison value to obtain a current value by the controller; and
calculating a virtual impedance value according to the current value and a droop factor by the controller.

12. The power supply control method of claim 11, wherein adjusting the first pulse width modulation signal into the second pulse width modulation signal according to the first output current and the sharing current by the controller further comprises:
calculating a virtual voltage value according to the virtual impedance value and the first output current by the controller; and
calculating a voltage calculated value according to an expected voltage and the virtual voltage value by the controller.

13. The power supply control method of claim 12, wherein adjusting the first pulse width modulation signal into the second pulse width modulation signal according to the first output current and the sharing current by the controller further comprises:
comparing the first output voltage with the calculated voltage value to generate a comparison signal by the controller; and
adjusting the first pulse width modulation signal into the second pulse width modulation signal according to the comparison signal by the controller.

14. The power supply control method of claim 10, wherein the sharing current is an average current of the first output current of each of the voltage conversion circuits.

15. The power supply control method of claim 10, wherein the voltage converter is a direct current (DC) to DC converter.
